(19) United States
(12) Patent Application Publication
(10) Pub. No.: US 2022/0094147 A1
(43) Pub. Date: Mar. 24, 2022

(54) Pass Through Driver

(71) Applicant: Arnold Staton Nicholas, St Joseph, MI (US)

(72) Inventor: Arnold Staton Nicholas, St Joseph, MI (US)

(21) Appl. No.: 16/239,323

(22) Filed: Jan. 3, 2019

Related U.S. Application Data
(60) Provisional application No. 62/709,006, filed on Jan. 3, 2018.

(51) Int. Cl. H02G 1/14

(52) U.S. Cl. CPC H02G 1/14

(57) ABSTRACT

When Electricians use MC (metal clad)/flexible armored cables to install an electrical box, the cables must be attached to the box using cable connectors. MC cable screw-in connectors are very difficult to physically insert into MC cable and there is no tool specifically designed to accomplish this task. Instead, Electricians need to insert these screws by hand or use a common wrench while simultaneously pushing on the screw. Other connector types are more expensive and risk damaging cable wires. The present invention is specifically designed to quickly and easily insert MC cable screw-in connectors. With a hex shaped well to fit standard MC cable screw-in connectors and a hollow handle, any length of electrical wire may be passed through the core of the tool so that the tool can be positioned to screw the connectors into the MC cable. While ideal for electrical applications as described above, the ability to pass material through the hollow handle while providing a driving action is not limited to electrical applications.

### BACKGROUND OF THE INVENTION

When Electricians use MC (metal clad)/flexible armored cables to install an electrical box, the cables must be attached to the box using cable connectors. MC cable screw-in connectors are very difficult to physically insert into MC cable because the tolerance between the screw and cable is very tight. Electricians need to insert these by hand or use a common wrench. However, the force required to insert the screw-in connector into the metal cable housing is significant and requires both twisting action as well as driving action. Applying this force by hand can quickly lead to fatigue or injury. While use of a wrench provides the twisting action, it does not easily support the simultaneous driving force required to fully insert the screw-in connector.

Because of this difficulty installing MC cable screw-in connectors, an alternate cable connector style (Saddle clamp) exists that avoids the driving force necessary to insert a connector screw into the MC cable. However, this alternative connector style is significantly more expensive than the screw-in type connectors and may crush the cable, potentially damaging the electrical wires.

### BRIEF SUMMARY OF THE INVENTION

This invention (Pass Through Driver) is a handheld tool with a hollow core and a hex shaped well on one side that is sized to fit MC cable screw-in connector heads. This allows the user to pass any length of wire through the driver and apply both twisting and driving action simultaneously to easily and quickly insert the screw-in connectors to MC cables. This ability to pass material through the hollow handle while providing a driving action is ideal for, but not limited to, electrical applications.

### BRIEF DESCRIPTION OF THE DRAWINGS

FIG. 1 shows an angled side view of the tool to demonstrate the general shape and proportion.

FIG. 2 shows the well in the tool that fits a hex shaped screw-in connector.

FIG. 3 illustrates a cross section of the tool to demonstrate the hollow core which allows electrical wires to pass through. It also indicates the well stop which enables screw-in connectors to be driven into MC cable.

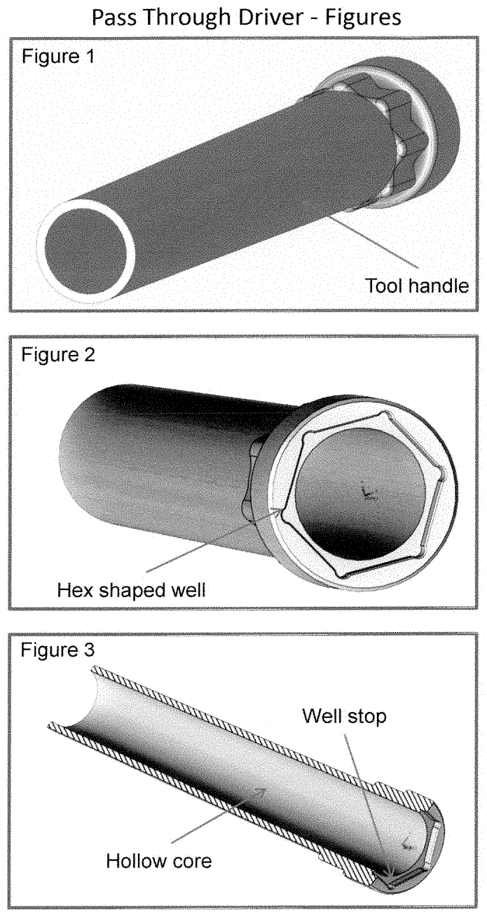

### DETAILED DESCRIPTION AND BEST MODE OF IMPLEMENTATION

This invention is a handheld tool specifically designed to quickly and easily insert MC cable screw-in connectors. A hex shaped well at one end is shaped to fit standard MC cable screw-in connectors. The well is stopped at the depth of the screw-in cable hex ring for optimal depth placement into the MC cable. This ensures the proper driving depth necessary to fully insert the screw into the MC cable. A hollow handle allows any length of electrical wires to pass through the core of the tool. As a result, this tool may be positioned to simultaneously apply both the twisting and driving action needed to easily, quickly and safely insert screw-in connectors into MC cable. The tool may be fabricated from any durable material, including but not limited to steel.

To install an MC cable screw-in connector using this tool: (1) Remove the nut portion of the screw-in connector. (2) Pass the electrical wire through the screw-in connector with the shaft side pointed toward the unstripped portion of MC cable. (3) Pass the electrical wire through the handle of the Pass Through Driver. (4) Position the shaft of the connector into the MC cable and insert the threaded portion of the screw-in connector into the Pass Through Driver opening so that the hex shaped connector head is properly seated in the tool well. (5) Simultaneously push and twist the driver until the screw-in connector is fully inserted into the MC cable. (6) Remove the Pass Through Driver and use the screw-in connector nut to connect the MC cable to an electrical box.

I claim:

1. The Pass Through Driver will allow Electricians to more easily install the screw-in connectors when attaching MC or Armored cable to electrical boxes.
